(19) United States
(12) Patent Application Publication
(10) Pub. No.: US 2004/0253442 A1
(43) Pub. Date: Dec. 16, 2004

(54) Method of forming a nanoporous film and compositions useful in such methods

(76) Inventors: Ervin Mubarekyan, Midland, MI (US); Thomas H. Kalantar, Midland, MI (US); H. Craig Silvis, Midland, MI (US); Q. Jason Niu, Midland, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/458,927

(22) Filed: Jun. 11, 2003

(51) Int. Cl. C08F 236/00

(52) U.S. Cl. 428/402.21; 525/331.9

(57) ABSTRACT

The present invention is a method comprising: providing a substrate; solvent coating onto the substrate a composition comprising a curable, highly aromatic, organic matrix material and porogens which are cross-linked nanoparticles consisting essentially of residual monomeric units derived from alkenyl functional and/or alkynyl functional aromatic monomers; and heating the coated substrate to a temperature no greater than 390° C., preferably no greater than 370° C., to cure the matrix and remove substantially all of the porogen material in a relatively short period of time to form small uniform pores in the cured highly organic matrix material.

### FIELD OF THE INVENTION

This invention relates to methods for formation of nanoporous films, particularly in the context of making ultra-low-dielectric constant layers in microelectronics manufacture.

### BACKGROUND OF THE INVENTION

As feature sizes in integrated circuits are decreasing an increasing need has developed for better dielectric materials to serve as insulators between metal lines in the circuit. In fact, the demand for low dielectric constant materials has reached a point where known solid materials will not be sufficient to meet the demand. Thus, a variety of methods for putting pores or voids into the dielectric materials have been devised.

The types of dielectric materials which serve as the matrix containing the pores are generally divided into three classifications: chemical vapor deposited (CVD) inorganic materials, spin-on organosilicate materials, and spin-on organic polymers.

For the spin-on materials, pores are typically taught to be formed by including a thermally labile material with the matrix material and heating the composition after coating on the substrate to cure the matrix and remove the thermally labile material. This thermally labile material is sometimes referred to as a porogen.

Among the thermally labile materials previously taught are abietic acid or rosin (see U.S. Pat. No. 6,280,794); ethylene glycol-polycaprolactone that are covalently bonded to a polymeric strand which will form the matrix (see U.S. Pat. No. 6,172,128, U.S. Pat. No. 6,313,185, and U.S. Pat. No. 6,156,812); linear, branched, and cross-linked polymers and cross-linked nanoparticles (see U.S. Pat. No. 6,093,636; US 2001/0040294; Xu et al., Polymeric Materials: Science & Engineering 2001, 85,502; and WO00/31183).

U.S. Pat. No. 6,420,441 taught a very wide variety of cross-linked nanoparticles made by solution or emulsion polymerization. These nanoparticles were taught as being substantially non-reactive with the B-staged dielectric material (i.e. matrix precursor material). While this patent teaches a wide variety of matrix materials, only silsesquioxane matrices were exemplified.

Similarly, U.S. patent application Ser. No. 10/366,494 taught highly advantageous cross-linked nanoparticles that had low levels of undesirable impurities.

U.S. patent application Ser. Nos. 10/365,938 and 10/077,646 also disclose processes for making porous films using cross-linked nanoparticles.

While these systems are capable of forming porous, low dielectric constant materials, a desire remains for systems that are more easily and quickly processed while maintaining the desired electrical and mechanical properties needed for integration in a microelectronic device. Some of these systems may also suffer from unacceptable levels of porogen residue remaining after the porogen removal step.

### SUMMARY OF THE INVENTION

While some fully organic cross-linked nanoparticles are taught to be effective as porogens in organosilicate systems, the inventors have discovered that these nanoparticles do not work well as porogens in highly aromatic organic polymer systems. The inventors have discovered that styrenic monomer based porogen nanoparticles are needed for use with highly aromatic organic polymer matrix materials. In addition, the new system for making nanoporous films has the advantage of reduction in the time and severity of conditions needed to produce the films, thereby, creating a manufacturing advantage.

Thus, the present invention is a method comprising:

providing a substrate;

solvent coating onto the substrate a composition comprising a curable, highly aromatic, organic matrix material and porogens which are cross-linked nanoparticles consisting essentially of residual monomeric units derived from alkenyl functional and/or alkynyl functional aromatic monomers; and

heating the coated substrate to a temperature no greater than 390° C., preferably no greater than 370° C., to cure the matrix and remove substantially all of the porogen material. The pores formed by this method preferably have average diameter of less than 30 nm, more preferably less than 20 nm, more preferably still less than 10 nm. Preferably, this heating step comprises maintaining the coated substrate at the recited cure temperature for no more than about one hour.

The present invention also includes a composition comprising a curable, highly aromatic, organic matrix material which cures at temperature no greater than 350° C.; a porogen material which is cross-linked nanoparticles consisting essentially of residual monomeric units derived from alkenyl functional and/or alkynyl functional aromatic monomers and which is characterized in that when heated to a temperature greater than the cure temperature of the matrix but no greater than about 390° C. substantially all of the porogen material is removed by decomposition and volatilization.

The present invention is also a cross-linked nanoparticle consisting essentially of residual monomer units (also referred to herein as RMU's) derived from alpha-methyl styrene, diisopropenyl benzene, and styrene monomers.

By “residual monomeric units (RMU's)” is meant the portion of the monomer which becomes part of the oligomer or polymer after reaction of the monomers with each other. RMU's are also sometimes referred to a “mers” or “repeat units”.

By “alkenyl functional and/or alkynyl functional aromatic monomers” is meant monomers consisting essentially of a substituted or unsubstituted aromatic ring structure and one or more functional groups selected from substituted or unsubstituted alkenyl (i.e. ethylenically unsaturated) groups and substituted or unsubstituted alkynyl groups. If substituted it is preferably inertly substituted—i.e. substituted with a group which does not effect or does not substantially effect the polymerization reaction of the monomer. Examples of preferred inert substituents include alkyl groups (preferably of 1 to 10 carbon atoms) and aryl groups (preferably of 6 to 10 carbon atoms). Examples of less preferred substituents include hydroxyl groups on the aromatic ring, carboxyl groups on the aromatic ring, amine groups on the aromatic ring. Preferably, the aromatic monomers are alkenyl functional aromatic monomers.

Substantially all of the porogen is considered to be removed when pores have been formed at substantially all the sites where porogen was located in the matrix and when the residual porogen material remaining has little impact on the properties of the porous film. To determine whether substantially all of the porogen material has been removed a variety of approaches may be used. One convenient method of determining whether substantially all the porogen has been removed is by comparing the refractive index to the refractive index of a sample having a known porosity, similar or identical matrix material, and similar pore sizes. Alternatively, determining whether substantially all the porogen has been removed can be performed by comparing infrared absorption bands (found by Fourier transform infrared spectroscopy, or FTIR) characteristic of the porogen of films after the heating step which is to remove the porogen to known standards or to the film prior to the heating step. For example, for preferred porogens in a preferred polyarylene base matrix material, an aliphatic peak at about a wavenumber of 2900 cm⁻¹ is corrected for any aliphatic groups that may be present in the matrix and is normalized relative to the amount of porogen initially present. Thickness of the film is taken into account in evaluating the strength of the peaks as well. Thus, the following equations can be used:

Normalized peak attributable to porogen=[(Aₛₐₘₚₗₑ/bₛₐₘₚₗₑ)−(Aₘₐₜᵣᵢₓ/bₘₐₜᵣᵢₓ)]/A_{porogen}/b_{porogen}

Approximation of % porogen remaining=100×(Normalized peak attributable to porogen in sample after heating for burn-out/Normalized peak attributable to porogen before heating for burn-out). Preferably, the percentage of porogen remaining based on these calculations is less than 5%, more preferably less than 2%, more preferably less than 1%, more preferably not detectable. An alternative test that may be used after initial screening to confirm porogen removal is by Thermal Desorption Spectroscopy. This method is used to detect volatile masses. Using the masses of the known or presumed depolymerization/decomposition products of the porogen, one can determine the extent of residual volatiles. A final option is to compare the weight of the sample after the heating step and compare the weight loss to the initial weight of the porogen in the sample. Obtaining accurate results with this option may be difficult to use with the coated films of matrix and porogen because one is relying on the calculated initial weight of the porogen in the sample based on volume, density and initial formulation of the sample. However, preferably, according to this approach less than 10%, more preferably less than 5%, most preferably less than 1% of the porogen based on initial weight of porogen in the sample remains.

### DETAILED DESCRIPTION OF THE INVENTION

The method of this invention can be practiced to form a nanoporous, organic, highly aromatic film on any substrate on which such a film is desired. The inventors anticipate that useful substrates will include substrates that contain transistors and other electronic devices and potentially metal interconnects, for example, on a silicon wafer.

The curable, highly aromatic, organic material which is used as the matrix may be any such material known in the art. An organic matrix material provides better toughness and mechanical integrity than is found in inorganic or organosilicate systems which tend to be brittle and lack durability when a significant void volume is incorporated into the material.

As used herein highly aromatic organic matrix material means the cured matrix, an uncured polymer, or oligomeric or monomeric precursors. The highly aromatic matrix material is characterized in that in its cured form the material comprises primarily (at least 50 mole % based on moles of RMU's in the material) aromatic ring structures in the polymer. The other 50 mole % may be a linking group such as the oxygen found in polyarylene ethers. Preferably at least 70 mole % of the polymer comprises aromatic ring structures. More preferably at least 90 mole % of the polymer comprises aromatic ring structures. The matrix material may comprise low levels of Si atoms, but is more preferably free of Si atoms or substantially free of Si atoms.

The matrix material of this invention is further characterized in that it can be cured from a state that is low enough in molecular weight to be spin coatable to a degree sufficient to support pores less than 30 nm, preferably less than 20 nm, more preferably less than 10 nm in average diameter at temperatures of about 350° C. or less. Preferably, the cure temperatures are greater than 200, more preferably greater than 250° C. The cure temperatures are preferably less than 325° C. The length of time required for cure will vary inversely with the cure temperature. However, preferably the material will reach a sufficient state of cure to support pores in less than one hour, preferably less than 45 minutes, more preferably less than 30 minutes.

Nonlimiting examples of curable, highly aromatic, organic matrix materials include polyarylene ethers. See e.g. U.S. Pat. Nos. 5,115,082; 5,155,175; 5,179,188; 5,874,516; 5,965,679; 6,121,495; 6,172,128; 6,313,185; and 6,156,812 and in PCT WO 91/09081.

Another highly aromatic curable organic matrix material which cures at temperatures of 350° C. and lower are the materials based on bis(ortho-diacetylene) monomers of the formula

(R—C≡C—)ₙAr-L[—Ar(—C≡C—R)ₘ]_{q}

wherein each Ar is an aromatic group or inertly-substituted aromatic group; each R is independently hydrogen, an alkyl, aryl or inertly-substituted alkyl or aryl group; L is a covalent bond or a group which links one Ar to at least one other Ar; n and m are integers of at least 2; q is an integer of at least 1; at least two of the ethynylic groups on one of the aromatic rings are ortho to one another. Preferably, at least two of the ethynylic groups on two of the aromatic rings are ortho to one another. See e.g. U.S. Pat. No. 6,252,001, incorporated herein by reference.

Other preferred highly aromatic matrix materials are those that cure via Diels-Alder reaction of diene groups and dienophile groups. Such curable matrix materials can be made by reaction of diene and dienophile functional monomers. To provide crosslinking, at least some of the monomers must have three reactive groups. In a most preferred version, a single monomer contains at least two of each type of reactive groups. In one preferred example, such monomers contain at least two dienophile groups and at least two ring structures which ring structures are characterized by the presence of two conjugated carbon-to-carbon double bonds and the presence of a leaving group L, wherein L is characterized that when the ring structure reacts with a dienophile in the presence of heat or other energy sources, L is removed to form an aromatic ring structure. The ring group is preferably a cyclopentadienone or pyrone. The dienophile is preferably an acetylene group.

Especially preferred exemplary monomers include monomers of formula I

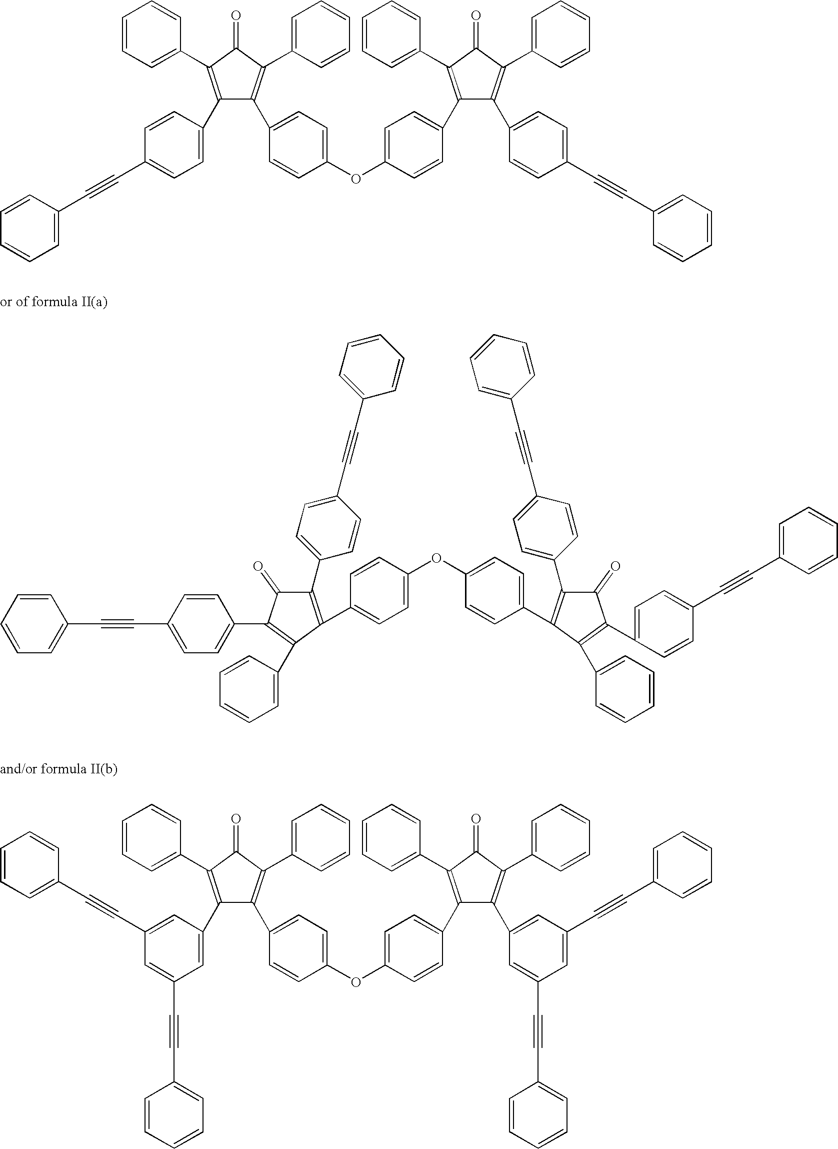

and the like. These monomers may be synthesized as taught in U.S. application Ser. No. 10/365,938.

Preferably the matrix materials are B-staged (i.e. partially polymerized) before coating onto the substrate. Precise B-staging conditions will vary with the matrix material selected. However, for preferred matrix materials, the B-staging occurs at 100 to about 210° C. for a time of about 2 to about 24 hours. The B-staged matrix material preferably has a number average molecular weight in the range of about 2000 to about 4000. If the molecular weight is too high, the material may not be optimal for spin coating or may prematurely cross-link and gel which will hamper further processing. If the molecular weight is too low the composition may suffer from crystallization of residual monomer.

The B-staging preferably occurs in a solvent such as mesitylene, methyl benzoate, ethyl benzoate, dibenzylether, diglyme, triglyme, diethylene glycol ether, diethylene glycol methyl ether, dipropylene glycol methyl ether, dipropylene glycol dimethyl ether, propylene glycol methyl ether, dipropylene glycol monomethyl ether acetate, propylene carbonate, diphenyl ether, cyclohexanone, butyrolactone, ethyl 3-ethoxypropionate and mixtures thereof. The preferred solvents are mesitylene, gamma-butyrolactone, cyclohexanone, diphenyl ether, ethyl 3-ethoxypropionate and mixtures of two or more of such solvents.

Preferably, at least a portion of the B-staging reaction, more preferably the entire B-staging reaction is performed in the presence of the porogen materials. This process enables residual carbon to carbon unsaturation in the porogen to react with the matrix material thereby grafting porogen and matrix together and inhibiting migration and agglomeration of the porogen material. However, having such residual carbon-to-carbon unsaturation is not sufficient to yield small templated (i.e. one pore for one porogen) pores. In addition to having a sufficient degree of residual carbon to carbon unsaturation (preferably the porogens have at least 15 mole % residual ethylenic unsaturated groups, relative to the maximum theoretically possible number of moles of pendant vinyl introduced into the porogen by the crosslinking moieties, and more preferably at least 20 mole % residual ethylenic unsaturated groups), the inventors have discovered that a porogen consisting essentially of residual monomeric units from alkenyl functional and/or alkynyl functional monomers is needed with highly aromatic matrix materials to avoid phase separation, agglomeration, large pores, and the like.

The porogens must be designed so as to be thermally labile in the relevant temperature range of about 300 to less than 400° C. in reasonable times, preferably of about one hour or less. Early styrene based porogens made using styrene and divinyl benzene required higher temperatures and/or longer times to be removed from the cured matrices.

The inventors initially examined acrylate and methacrylate monomers as comonomers in a porogen when investigating methods of lowering thermal decomposition temperature and/or time of decomposition. However, porogens made with effective amounts of these monomers to meet the requirements for decomposition temperature and time even when combined with styrenic monomers were found to be not optimal for use with highly aromatic organic polymer matrix materials. In fact, although grafting sites were available on the porogen, macrophase separation, agglomeration and/or large pores were nevertheless observed.

The inventors thus discovered that a porogen entirely based on alkenyl functional (e.g. styrenic monomers) or alkynyl functional aromatic monomers could be made which provided suitable compatibility with the matrix. The inventors were able to design such a porogen that would thermally decompose in the desired temperature range and time.

Thus, the porogens useful in this invention comprise at least some (preferably at least 10%, more preferably at least 15%, and most preferably at least 20%, preferably less than 80%, more preferably less than 60% and most preferably less than 50% by weight based on weight of porogen) residual monomeric units derived from one or more multifunctional alkenyl functional and/or alkynyl functional aromatic monomer (i.e. a monomer that has at least two carbon to carbon unsaturated groups—preferably adjacent to the aromatic ring, i.e. C═C-AR—in the aliphatic portion of the monomer) to enable crosslinking. These RMU's can be referred to as “cross-link RMU's”. In addition, the porogens preferably comprise at least 20 weight percent, more preferably at least 30 weight percent of residual monomeric units having a relatively low thermal stability. These RMU's with relatively low thermal stability may be derived from the same or different monomers as the cross-link RMU's—i.e. the cross-link RMU's may serve the function of having relatively low thermal stability.

Preferably, the monomers used in making the porogens are selected from compounds represented by the formula:

Ar—(R)x

where Ar is independently in each compound a substituted or unsubstituted aromatic ring structure and R is independently in each compound an aliphatic group (preferably of from 2 to 10 carbon atoms) or an aromatic terminated or substituted aliphatic group (preferably of 8-12 carbon atoms) wherein R includes at least one carbon-to-carbon double or triple bond, and x is independently in each compound 1, 2, or 3.

The RMU's having a relatively low thermal stability are characterized in that they have a lower thermal stability than polystyrene (PS), poly(methyl acrylate) (PMA), or PS/PMA copolymers. Copolymerizing these monomers with styrene lowers the depolymerization temperature of styrene and enables the porogen to break apart and the decomposition products volatilize at temperatures under 400° C., preferably under 390° C., and most preferably under 370° C. Preferably the porogens do not depolymerize and volatilize however until after the matrix material is cured to an extent sufficient to support pores without collapse or agglomeration. Examples of aromatic monomers that are useful in lowering the thermal stability of the polymer by providing RMU's with relatively low thermal stability include: diisopropenylbenzene(DIB), 1,1-diphenylethylene, 1,2-bis(isopropenylphenyl)ethane, alpha-substituted vinyl aromatic monomers such as alpha-methylstyrene (AMS), alpha-carboxymethylstyrene, and the like.

Examples of multifunctional alkenyl aromatic monomers and alkynyl aromatic monomers useful in forming the cross-link RMU's include di-, tri-, tetra- or higher multifunctional ethylenically unsaturated styrenics, such as divinylbenzene (DVB), diisopropenylbenzene (DIB), trivinylbenzene, divinyltoluene, divinylxylene, triisopropenylbenzene, and the like; and di-, tri-, tetra- or higher multi functional ethylenically unsaturated higher aromatics, such as divinylnaphthalene, divinylanthracene, and the like.

Other monomers useful in forming the porogens include monofunctional vinylaromatic monomers: styrene, alkyl substituted styrenes, such as vinyltoluene, 4-methylstyrene, dimethylstyrenes, trimethylstyrenes, tert-butylstyrene, ethylvinylbenzene, vinylxylenes, and the like; aryl-substituted styrenes, such as phenylstyrene, 4-benzoylstyrene, and the like; alkylaryl-substituted styrenes; arylalkynyl alkyl-substituted styrenes; 4-phenylethynylstyrene, phenoxy-, alkoxy-, carboxy-, hydroxy-, or alkyloyl- and aroyl-substituted styrenes; higher aromatics, such as vinylnaphthalene, vinylanthracene; stilbene; beta-substituted vinyl aromatic monomers such as beta-methylstyrene, beta-carboxymethylstyrene, and the like; and substituted versions thereof.

Preferably, the porogens of this invention comprise the reaction product of the following reactants:

At least one monomer which provides cross-linking in amounts of at least 10%, more preferably at least 15%, and most preferably at least 20%, and no more than 80%, more preferably no more than 60%, more preferably still no more than 50% and most preferably no more than 45%. More preferably, this monomer provides thermal stability characteristics the same as or similar to those of diisopropenylbenzene. Most preferably, this monomer is diisopropenylbenzene.

At least one low thermal stability monomer in amounts of at least 5%, more preferably at least 10%, more preferably still at least 15%, more preferably yet, at least 20% and most preferably at least 30% and no more than 90%, more preferably no more than 80%, more preferably yet no more than 60% and most preferably no more than 50%. Preferably at least one low thermal stability RMU provides thermal stability characteristics similar to those of alpha-methylstyrene. Most preferably this monomer is alpha-methylstyrene.

One or more mono-ethylenically unsaturated aromatic monomer which preferably provides similar thermal stability characteristics as styrene in amounts of up 80%, more preferably up to 70%, and most preferably up to 50%. Preferably this monomer is styrene. Preferably, styrene or a suitable substituted monomer is present in amounts of at least 30%; more preferably at least 40%.

These percentages are weight percent based on total weight of the reactants.

These porogens can be made by known methods for making cross-linked nanoparticles. The porogens preferably are made by use of a non-ionic surfactant in an emulsion polymerization as disclosed in U.S. application Ser. No. 10/366,494. Less preferably, the porogens may be made by emulsion polymerization using ionic surfactant and later purified by ionic exchange. Examples of such non-ionic surfactants include polyoxyethylenated alkylphenols (alkylphenol “ethoxylates” or APE); polyoxyethylenated straight-chain alcohols (alcohol “ethoxylates” or AE); polyoxyethylenated secondary alcohols, polyoxyethylenated polyoxypropylene glycols; polyoxyethylenated mercaptans; long-chain carboxylic acid esters; glyceryl and polyglyceryl esters of natural fatty acids; propylene glycol, sorbitol, and polyoxyethylenated sorbitol esters; polyoxyethylene glycol esters and polyoxyethylenated fatty acids; alkanolamine condensates; alkanolamides; alkyl diethanolamines, 1:1 alkanolamine-fatty acid condensates; 2:1 alkanolamine-fatty acid condensates; tertiary amine N-oxides, tertiary acetylenic glycols (e.g. R1R2C(OH)C≡CC(OH)R3R4); polyoxyethylenated silicones; n-alkylpyrrolidones; polyoxyethylenated 1,2-alkanediols and 1,2-arylalkanediols; and alkylpolyglycosides. Alkyl polyethoxylates, polyoxyethylenated 1,2-alkanediols, and alkyl aryl polyethoxylates are preferred. Examples of commercially available non-ionic surfactants include Tergitol™ surfactants from The Dow Chemical Company, and Triton™ surfactants from The Dow Chemical Company. Preferably the initiator is a compound which is organic based such as 2,2′-azobis(2-amidinopropane)dihydrochloride, for example, and redox initiators, such as H₂O₂/ascorbic acid or tert-butyl hydroperoxide/ascorbic acid, or oil soluble initiators such as di-tert-butyl peroxide, tert-butyl peroxybenzoate or 2,2′-azoisobutyronitrile.

The porogens may be combined with the precursor monomers for the matrix material prior to B-staging (i.e. partial polymerization of the matrix material) or may be later added to the B-staged material. Since the porogens tend to have residual ethylenically unsaturated groups, they advantageously may react with the matrix material during B-staging or early cure of the matrix, thereby inhibiting migration and agglomeration of the porogens in the coated film. Preferably the porogens have at least 15 mole % residual ethylenic unsaturated groups, relative to the maximum theoretically possible number of moles of pendant vinyl introduced into the porogen by the crosslinking moieties, and more preferably at least 20 mole % residual ethylenic unsaturated groups.

The porogens preferably have an average diameter as determined by size-exclusion chromatography with universal calibration and differential viscometric detection (SEC/DV) of less than 30 nm, more preferably less than 20 nm, most preferably less than 10 nm.

The SEC/DV test is performed as follows: A good solvent for the sample and for the standard, preferably polystyrene, is selected. Tetrahydrofuran is a preferred solvent. The column used for the SEC separation contains porous, crosslinked PS particles and the like, and is well suited for separating polystyrene and similar compounds according to size (hydrodynamic volume) in solution. Conventional high pressure liquid chromatography (HPLC) equipment is used for solvent delivery and sample introduction. A differential refractive index detector is used to detect the eluting sample concentration. A differential viscometer is used to detect the specific viscosity of the eluting polymer solution. These detectors are commercially available for example under the e.g. Model 2410 differential refractive index detector from Waters and model H502 differential viscometer from Viscotek, Inc. Because the concentrations injected on the SEC system are small, the ratio of specific viscosity to concentration at each SEC elution volume increment provides a reasonable estimate of the intrinsic viscosity of the polymer eluting in the particular volume increment.

The SEC/DV test enables determination of the following properties for the sample: absolute molecular weight distribution (and number average, weight average and z-average molecular weights); collapsed and swollen (i.e. in solvent) particle size distribution (and peak and weight average diameters); the Mark-Houwink plot (log [η] versus log M, where [η] is the intrinsic viscosity and M is the molecular weight); the volume swell factor (VSF) in the test solvent, and the PS-apparent molecular weight distribution (and molecular weight averages and polydispersity). The universal calibration curve is determined using narrow molecular weight distribution polystyrene (PS) and, more preferably also, narrow molecular weight distribution polyethylene oxide (PEO) standards. The curve is a plot of log([η]*M) versus elution volume. The product of [η]*M is proportional to hydrodynamic volume. Because ideal SEC sorts molecules according to hydrodynamic volume, a single universal calibration curve is obtained independent of polymer composition or architecture. Thus, with knowledge of the universal calibration curve and the intrinsic viscosity at every SEC elution volume increment, the absolute molecular weight of an unknown sample can be calculated at each elution volume increment. In addition, a flow-through static laser light scattering detector can be connected in series with the RI and DV detectors; this detector will provide a corresponding measure of the absolute molecular weight of the unknown sample.

Weight average diameter of the dry collapsed particle, Dw, is calculated as follows:

Absolute M and polymer concentration data at each elution volume increment allow for the calculation of absolute molecular weight averages and distributions. Transforming the absolute molecular weight axis into a particle size axis is performed according to the equation below:

Dw (in nm)=2*[(Mw)*(L⁻¹)*(density⁽⁻¹⁾)*(10²¹)*0.75*(π⁻¹)]^{1/3}

where Mw is the absolute weight average molecular weight in g/mol, L is Avogadro's number, density is the density of the dry polymer in g/cm³, 10²¹ is a factor to convert cm³ to nm³, and a spherical shape is assumed (volume, V=4/3πr³). The factor 2 converts r (radius) to Dw (weight average diameter).

The composition preferably further comprises a solvent. Examples of suitable solvents include mesitylene, methyl benzoate, ethyl benzoate, dibenzylether, diglyme, triglyme, diethylene glycol ether, diethylene glycol methyl ether, dipropylene glycol methyl ether, dipropylene glycol dimethyl ether, propylene glycol methyl ether, dipropylene glycol monomethyl ether acetate, propylene carbonate, diphenyl ether, cyclohexanone, butyrolactone and mixtures thereof. The preferred solvents are mesitylene, gamma-butyrolactone, cyclohexanone, diphenyl ether, ethyl 3-ethoxypropionate and mixtures of two or more of such solvents. The amount and selection of solvents preferably is such to enable spin coating of a layer of the desired thickness.

The composition is then coated onto the substrate. The coating optionally may be subject to one or more initial heating steps (e.g. on a hotplate) to remove solvent and/or provide some initial cure to set the matrix material. Preferably, these initial heating steps are in the range of about 150 to 300° C. for times in the range of 30 seconds to about 5 minutes.

After the initial heating steps (or after coating if no initial heating steps are used), the composition is subjected to one or more heating steps to complete cure and remove the porogen. Preferably this heating step occurs in an oven or furnace in an inert atmosphere. The temperature is raised to a temperature less than 400° C., preferably no more than 390° C., more preferably no more than 380° C., most preferably no more than about 370° C. The coated substrate is maintained at the recited temperature for a time preferably no more than 1 hour, more preferably less than 1 hour, more preferably no more than 45 minutes, and most preferably no more than 30 minutes. Preferably, substantially all the porogen is removed by this heating step.

One method of determining whether substantially all the porogen has been removed is by comparing the refractive index to the refractive index of a sample having a known porosity, similar or identical matrix material, and similar pore size. Alternatively, examining trends in refractive index as heating progresses can illuminate whether porogen removal is continuing—i.e. if refractive index is still trending down significantly with additional heating it is likely that porogen removal is continuing.

Another method for determining whether substantially all the porogen has been removed is by comparing FTIR peaks characteristic of the porogen of films after the heating step which is to remove the porogen to known standards or to the film prior to the heating step. For example, for preferred porogens in preferred polyarylene base matrix material, an aliphatic peak at about a wavenumber of 2900 cm⁻¹ is corrected for any aliphatic groups that may be present in the matrix and is normalized relative to the amount of porogen initially present. Thickness of the film is taken into account in evaluating the strength of the peaks as well. Thus, the following equations can be used:

Normalized peak attributable to porogen=[(Aₛₐₘₚₗₑ/bₛₐₘₚₗₑ)−(Aₘₐₜᵣᵢₓ/bₘₐₜᵣᵢₓ)]/A_{porogen}/b_{porogen}

Approximation of % porogen remaining=100×(Normalized peak attributable to porogen in sample after heating for burn-out/Normalized peak attributable to porogen before heating for burn-out). Preferably, the percentage of porogen remaining based on these calculations is less than 5%, more preferably less than 2%, more preferably less than 1%, more preferably not detectable.

An alternative test that may be used after initial screening to confirm porogen removal is by Thermal Desorption Spectroscopy. This method is used to detect volatile masses. Using the masses of the known or presumed depolymerization/decomposition products of the porogen, one can determine the extent of residual volatiles.

A final option is to compare the weight of the sample after the heating step and compare the weight loss to the initial weight of the porogen in the sample. Obtaining accurate results with this option may be difficult to use with the coated films of matrix and porogen because one is relying on the calculated initial weight of the porogen in the sample based on volume, density and initial formulation of the sample. However, preferably, according to this approach less than 10%, more preferably less than 5%, most preferably less than 1% of the porogen based on initial weight of porogen in the sample remains.

Additional processing steps may occur before or after the heating step. In microelectronics manufacture, such processing steps include patterning, etching, metal deposition in etch vias and trenches, chemical mechanical polishing and such other process steps used in integration of microelectronic devices. These process steps are well known in the integration of microelectronic devices and may occur according to known processes.

### EXAMPLES

### Example 1

### Illustrative Example of Method of Making Porogens

Deionized water (220 grams) and 42.9 g Igepal CO880, 6.87 g Igepal CO660 (surfactants both from Rhodia, Inc.) are combined in an erlenmeyer flask and stirred to make a homogeneous surfactant solution. The surfactant solution is charged into a jacketed reactor and was stirred @ 200 rpm for 30 minutes while being flushed with nitrogen. A 80/20 weight/weight mixture of methyl acrylate/allyl methacrylate is charged into a 100 ml glass syringe. A 1 weight percent solution of ascorbic acid in DI water and a 9.9 weight percent solution of hydrogen peroxide in DI water are charged separately into 10 ml glass syringes for use as initiators. First, 10 ml each of a 1 weight percent ascorbic acid solution and a 9.9 weight percent hydrogen peroxide solution in DI water are added to the reactor consecutively. Then, the following mixtures are injected into the reactor: 16.9 ml of the monomer mixture at the rate of 4 ml/hr, 10 ml of each initiator solution at the rate of 2 ml/hr. The reactor is gently purged with nitrogen, while being stirred gently and the reaction temperature is held constant at 25° C. throughout the reaction. At the end of 5 hours, the resulting latex is reacted for an additional 5 minutes and collected.

SEC/DV analysis of particles prepared according to a process like that set forth above showed that the latex had a weight average particle size of 18.3 nm with a volume swell factor (VSF) of 3.14. A TGA analysis of the particles indicated onset of weight loss at a temperature of about 280 to 290° C. and rapid weight loss at 330 to 370° C.

### Example 2

### Illustrative Example of Method of Making Porogens

Fifty grams Tergitol 15S15, 5 g Tergitol 15S9 (surfactants both from Dow Chemical) and 216 g DI water are combined in an Erlenmeyer flask and stirred to make a homogeneous surfactant solution. The surfactant solution is charged into a jacketed reactor and was stirred @ 300 rpm for 30 minutes while being flushed with nitrogen. A 60/20/20 weight ratio mixture of styrene/alpha-methylstyrene/1,3-diisopropenylbenzene is charged into a 100 ml glass syringe. A 3 weight percent solution of ascorbic acid in DI water and a 30 weight percent solution of hydrogen peroxide in DI water are charged separately into 10 ml glass syringes. Then, the following amounts of the monomer mixture and both initiator solutions are injected into the reactor: 30 ml of the monomer mixture at the rate of 15 ml/hr, 10 ml of each initiator solution at the rate of 5 ml/hr. The reactor is gently purged with nitrogen, while being stirred gently and the reaction temperature is held constant at 30° C. throughout the reaction. At the end of 2 hours, 3 g of a 30% hydrogen peroxide solution and 5 g of a 2% ascorbic acid solution are added into the reactor and the latex was reacted for an additional 30 minutes.

An SEC/DV and laser light scattering analysis of particles made substantially according to the method set forth showed that the latex had a weight average particle size of 11 nm with a VSF of 2.03. A TGA analysis of the particles indicated rapid weight loss at temperatures of about 330 to 370° C.

### Example 3

### Comparative

A 1.71 gram quantity of a methyl acrylate-co-allyl methacrylate (8/2 weight ratio) polymer porogen was dispersed in 5 mL of gamma-butyrolactone and 3 mL of toluene. Upon complete dispersion, the solution was combined with 4.00 grams of the monomer of formula 1 and 3.33 additional mL of gamma-butyrolactone in a 50 mL flask equipped with a small distillation apparatus connected to a nitrogen and vacuum source. The mixture was degassed by repeated evacuation and flushing with nitrogen gas, and then it was heated to 200° C. with stirring by means of a heated silicon oil bath. As the temperature rose to ˜170° C., the toluene was distilled over and the resulting solution was allowed to polymerize for a period of 5 hours. Upon cooling to ˜150° C., the solution was diluted to a concentration of 20 wt % total solids by the addition of 14.28 mL of ethyl 3-ethoxypropionate. This solution was then filtered through a 0.45 um syringe filter and was subsequently spun on a silicon wafer and baked on a hot plate for 2 minutes at 150° C., followed by heating to 400° C. at a heating rate of 7° C./min in an oven under a nitrogen atmosphere and maintained at 400° C. for 2 hours The resulting cured film was extremely hazy, indicating macro-phase separation between the acrylate-based porogen polymer and the matrix polymer. Because of the poor film quality, the refractive index could not be measured. The light scattering index for the film was measured at 82.1, indicating relatively large domains of phase separated polymer. A light scattering index of about 20 or less is considered indicative of small, uniform pores (e.g. 20 nm or less) in this system.

### Example 4

### Comparative

A 1.71 gram quantity of a methyl acrylate-co-styrene-co-diisopropylbenzene (6/2/2 weight ratio) polymer porogen was dispersed in 5 mL of gamma-butyrolactone and 3 mL of toluene. Upon complete dispersion, the solution was combined with 4.00 grams of the monomer of formula I and 3.33 additional mL of gamma-butyrolactone in a 50 mL flask equipped with a small distillation apparatus connected to a nitrogen and vacuum source. The mixture was degassed by repeated evacuation and flushing with nitrogen gas, and then it was heated to 200° C. with stirring by means of a heated silicon oil bath. As the temperature rose to ˜170° C., the toluene was distilled over and the resulting solution was allowed to polymerize for a period of 5 hours. Upon cooling to 150° C., the solution was diluted to a concentration of 20 wt % total solids by the addition of 14.25 mL ethyl 3-ethoxypropionate. This solution was then filtered through a 0.45 um nylon syringe filter and was subsequently spun on a silicon wafer and baked on a hot plate for 2 minutes at 150° C., followed by heating to 400° C. at a heating rate of 7° C./min in an oven under a nitrogen atmosphere and maintained at 400° C. for 2 hours. The resulting cured film was somewhat hazy, indicating macro-phase separation between the porogen polymer and the matrix polymer. The refractive index value for the resulting film was measured at 1.5178, indicating that the sample was indeed porous. However, the light scattering index for the film was measured at 5698, indicating relatively large domains of phase separated polymer, which would render the film unsuitable for dielectric applications.

### Example 5

### Comparative

A 1.71 gram quantity of a methyl acrylate-co-alpha-methylstyrene-co-diisopropylbenzene (4/4/2 weight ratio) polymer porogen was dispersed in 5 mL of gamma-butyrolactone and 3 mL of toluene. Upon complete dispersion, the solution was combined with 4.00 grams of monomer of formula 1 and 3.33 additional mL of gamma-butyrolactone in a 50 mL flask equipped with a small distillation apparatus connected to a nitrogen and vacuum source. The mixture was degassed by repeated evacuation and flushing with nitrogen gas, and then it was heated to 200° C. with stirring by means of a heated silicon oil bath. As the temperature rose to ˜170° C., the toluene was distilled over and the resulting solution was allowed to polymerize for a period of 5 hours. Upon cooling to ˜150° C., the solution was diluted to a concentration of 20 wt % total solids by the addition of 14.25 mL ethyl 3-ethoxypropionate. This solution was then filtered through a 0.45 um nylon syringe filter and was subsequently spun on a silicon wafer and baked on a hot plate for 2 minutes at 150° C., followed by heating to 400° C. at a heating rate of 7° C./min in an oven under a nitrogen atmosphere and maintained at 400° C. for 2 hours. The resulting cured film was somewhat hazy, indicating macro-phase separation between the porogen polymer and the matrix polymer. The refractive index value for the resulting film was measured at 1.5973, indicating that the sample possessed a low degree of porosity. However, the light scattering index for the film was measured at 3115, indicating relatively large domains of phase separated polymer, which would render the film unsuitable for dielectric applications.

### Examples 6-10

Example of Low Temperature Burnout Porous Dielectric Films

A series of porous dielectric films were prepared by heating a combination of the matrix monomer of formula I and selected porogens in gamma-butyrolactone at 200° C. for a period of 4-5 hours. The porogen accounted for 15 wt % of the combined matrix and porogen solids. The composition of the porogens was varied by the substitution of some portion of the styrene component with alpha-methylstyrene (AMS). 1,3-Diisopropenylbenzene (DIB) was used to provide cross linking in the particle and also to lower the thermal stability relative to particles made using cross-linkers such as divinylbenzene. The resulting B-staged solutions were then diluted to 20 wt % total solids by the addition of ethyl 3-ethoxypropionate. The solutions were subsequently spun onto silicon wafers, which were then heated on a 150° C. hot plate for 2 minutes to substantially remove the solvents, followed by curing in a furnace that was heated at a rate of 7° C./min to 370° C., and then held there for 30, 60, 90, and 120 minutes. The refractive index of the resulting films was then measured and the data appear in the following table.

| | Example 6 | Example 7 | Example 8 | Example 9 | Example 10 |
|---|---|---|---|---|---|
| Porogen composition | 0/75/25 | 10/70/20 | 20/60/20 | 30/50/20 | 40/40/20 |
| AMS/Styrene/DIB weight | | | | | |
| ratios | | | | | |
| Refractive index after 30 | 1.5956 | 1.5927 | 1.5576 | 1.5511 | 1.5512 |
| minutes at 370° C. | | | | | |
| Refractive index after 60 | 1.5938 | 1.5624 | 1.5616 | 1.5591 | 1.5604 |
| minutes at 370° C. | | | | | |
| Refractive index after 90 | 1.5750 | 1.5558 | 1.5546 | 1.5527 | 1.5581 |
| minutes at 370° C. | | | | | |
| Refractive index after 120 | 1.5528 | 1.5434 | 1.5491 | 1.5475 | 1.5500 |
| minutes at 370° C. | | | | | |

A refractive index value of 1.54 to 1.56 was indicative of removal of substantially all the porogen. Light scattering index measurements for all of these samples were less than 20, indicating small uniform pores were formed.

### Example 11

An acetylene and cyclopentadienone multifunctional monomer is reacted in the presence of porogens similar to those used in Example 8 to form a B-staged formulation according to processes like the one set forth, for example, in Example 3. This formulation is diluted with ethyl 3-ethoxypropionate to the desired percentage of solids and spin coated. The sample is baked at about 150° C. FTIR analysis of samples prepared according this procedure before and after heating for burnout indicated that less than 5% of the porogen was remaining after heating to 370° C. for one hour.

### Example 12

Samples prepared according to a procedure as set forth in Example 11 and subjected to heating at 370° C. for one hour were tested by Thermal Desorption Spectroscopy. This test indicated that the porogen was substantially all removed as very low response indicative of mass 104 (styrene) was detected.

What is claimed is:

1. A composition comprising a curable, highly aromatic, organic matrix material which cures at a temperature no greater than 350° C.; a porogen material which is cross-linked nanoparticles consisting essentially of residual monomeric units derived from alkenyl functional and/or alkynyl functional aromatic monomers and which is characterized in that when heated to a temperature greater than the cure temperature of the matrix but no greater than about 390° C. for no more than one hour, substantially all of the porogen material is removed.

2. The composition of claim 1 wherein the matrix material is a polyarylene or polyarylene ether.

3. The composition of claim 1 wherein porogen material consists essentially of residual monomeric units derived from diisopropenylbenzene, alpha-methylstyrene and styrene.

4. The composition of claim 3 wherein the porogen material consists essentially of residual monomeric units derived from the following reactants: 5 to 90% by weight alpha-methylstyrene, 10 to 80% by weight diisopropenylbenzene, and 0 to 80% by weight styrene.

5. The composition of claim 1 wherein the highly aromatic organic matrix material is the reaction product of diene and dienophile functional monomers.

6. The composition of claim 5 wherein the diene and dienophile functional monomers are selected from formula I

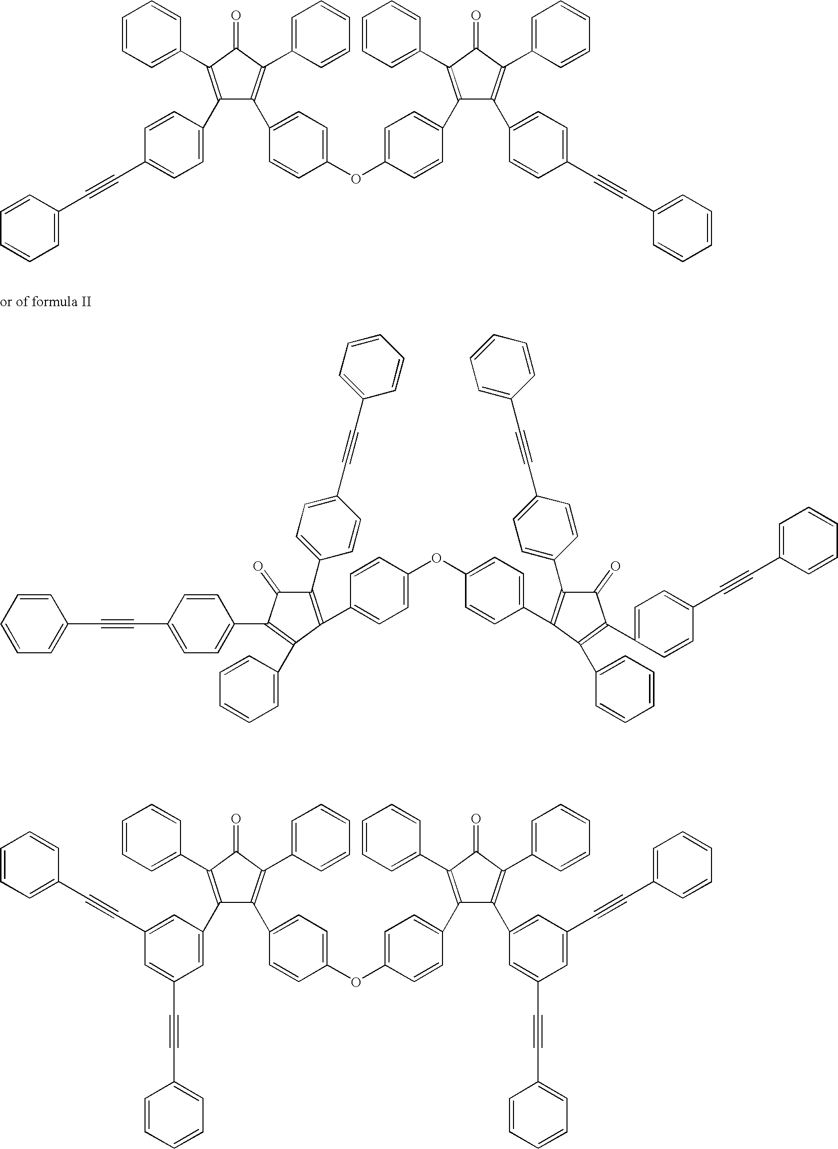

7. The composition of claim 3 wherein the porogen material consists essentially of residual monomeric units derived from the following reactants: 5 to 50% by weight alpha methyl styrene, 10 to 50% by weight diisopropenylbenzene, and 30 to 70% by weight styrene.

8. The composition of claim 1 wherein the porogen material comprises at least 20% by weight of residual monomeric units derived from low thermal stability alkenyl functional and/or alkynyl functional aromatic monomers.

9. The composition of claim 1 wherein the porogen material comprises at least 40% by weight of residual monomeric units derived from low thermal stability alkenyl functional and/or alkynyl functional aromatic monomers.

10. The composition of claim 2 wherein the polymer cures by Diels-Alder reaction.

11. A cross-linked nanoparticle having an average diameter of less than 30 nm consisting essentially of residual monomeric units derived from alpha-methylstyrene, diisopropenylbenzene and styrene.

12. The nanoparticle of claim 11 wherein substantially all of the particle depolymerizes and is volatilized at a temperature of less than 390° C. in less than one hour.

13. The nanoparticle of claim 11 wherein the residual monomeric units derived from alpha-methylstyrene are present in amounts of 5 to 90 weight %, residual monomeric units derived from the diisopropenylbenzene are present in amounts from 10 to 80 weight %, and the residual monomeric units derived from styrene are present in amounts from 0 to 80 weight %.

14. The nanoparticle of claim 11 wherein the residual monomeric units derived from alpha-methylstyrene are present in amounts of 5 to 50 weight %, residual monomeric units derived from the diisopropenylbenzene are present in amounts from 10 to 50 weight %, and the residual monomeric units derived from styrene are present in amounts from 30 to 70 weight %.

15. A method of making a porous film comprising
providing a substrate;
solvent coating onto the substrate a composition comprising a curable, highly aromatic, organic matrix material and porogens which are cross-linked nanoparticles consisting essentially of residual monomeric units derived from alkenyl functional and/or alkynyl functional aromatic monomers; and
heating the coated substrate to a temperature no greater than 390° C. for no more than one hour to cure the matrix and remove substantially all of the porogen material and form voids in the matrix material.

16. The method of claim 15 wherein the voids have an average dimension of less than 20 nm.

17. The method of claim 15 wherein the voids have an average dimension of less than 10 nm.

18. The method of claim 15 wherein the heating step comprises maintaining the coated substrate at the recited cure temperature for no more than about one hour.

19. The method of claim 15 wherein removal of substantially all of the porogen material is confirmed by a method selected from examining the refractive index, examining FTIR for a peak characteristic of the porogen, thermal desorption spectroscopy, or comparing weight loss of the sample to original weight of porogen in the sample.

20. The method of claim 15 wherein the heating step comprises heating to a temperature no greater than 370° C.

21. The method of claim 15 wherein the matrix material is a polyarylene or polyarylene ether.

22. The method of claim 15 wherein porogen material consists essentially of residual monomeric units derived from diisopropenylbenzene, alpha-methylstyrene and styrene.

23. The method of claim 15 wherein the porogen material consists essentially of residual monomeric units derived from the following reactants: 5 to 90% by weight alpha-methylstyrene, 10 to 80% by weight diisopropenylbenzene, and 0 to 80% by weight styrene.

24. The method of claim 15 wherein the highly aromatic organic matrix material is the reaction product of diene and dienophile functional monomers.

25. The method of claim 15 wherein the diene and dienophile functional monomers are selected from formula I

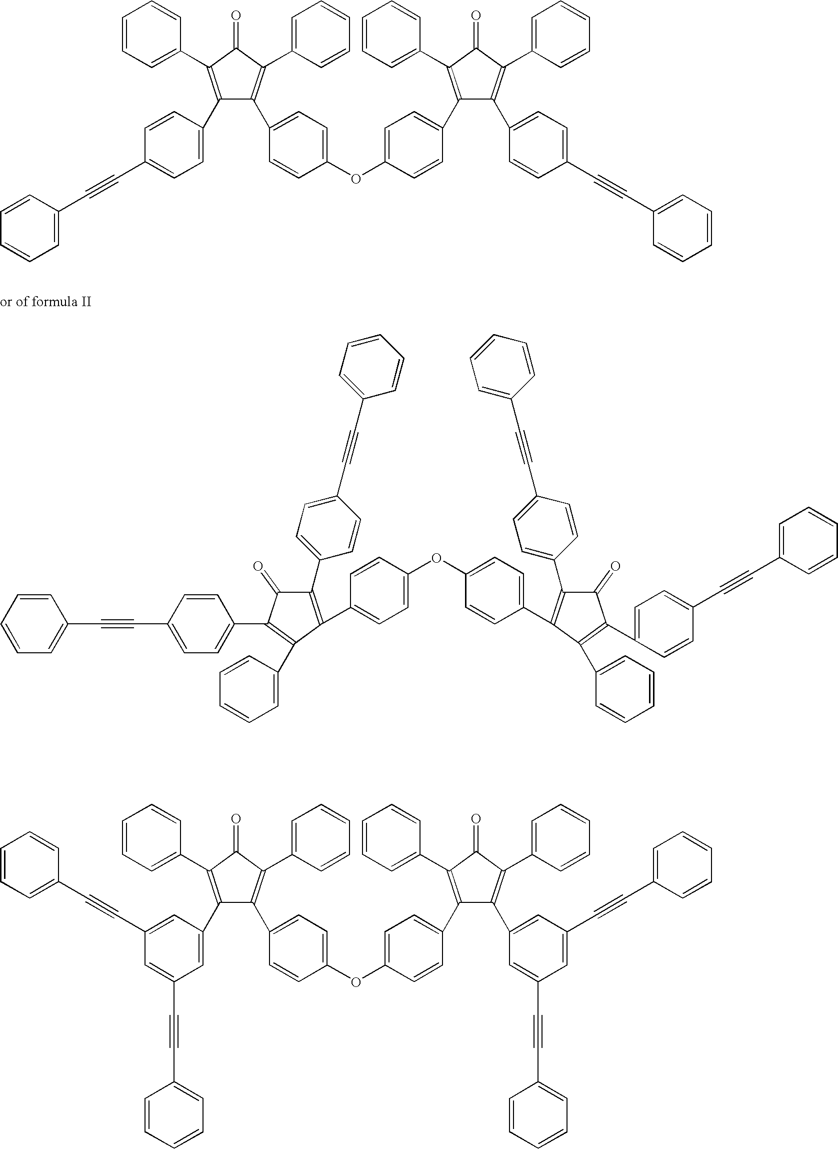

26. The method of claim 15 wherein the porogen material consists essentially of residual monomeric units derived from the following reactants: 5 to 50% by weight alpha-methylstyrene, 10 to 50% by weight diisopropenylbenzene, and 30 to 70% by weight styrene.

27. The method of claim 15 wherein the porogen material comprises at least 20% by weight of residual monomeric units derived from low thermal stability alkenyl functional and/or alkynyl functional aromatic monomers.

28. The method of claim 15 wherein the porogen material comprises at least 40% by weight of residual monomeric units derived from low thermal stability alkenyl functional and/or alkynyl functional aromatic monomers.

29. The method of claim 15 wherein the polymer cures by Diels-Alder reaction.

30. The method of claim 19 wherein the residual peak in FTIR for the porogen indicates less than 5% of porogen remains.

31. The method of claim 19 wherein the weight loss indicates that less than 5% of the porogen material remains.

32. The method of claim 19 wherein the porogen is not detectable by thermal desorption spectroscopy.

33. A film made by the method of claim 15.

34. An integrated circuit article comprising the film of claim 33.

35. An electronic device comprising the integrated circuit article of claim 34.
